(19) United States
(12) Patent Application Publication
(10) Pub. No.: US 2016/0012432 A1
(43) Pub. Date: Jan. 14, 2016

(54) UNIVERSAL ELECTRONIC PAYMENT CREDENTIAL PROCESSING

(71) Applicant: THE TORONTO-DOMINION BANK, Mississauga (CA)

(72) Inventors: Mahnaz Meshkati, Toronto (CA); John Anthony Tarnowski, Calgary (CA); Lauren van Heerden, Bedford, NH (US); Orin Del Vecchio, Richmond Hill (CA); Paul Mon-Wah Chan, Markham (CA); Dino D'Agostino, Richmond Hill (CA)

(21) Appl. No.: 14/796,275

(22) Filed: Jul. 10, 2015

Related U.S. Application Data
(60) Provisional application No. 62/022,831, filed on Jul. 10, 2014.

(51) Int. Cl. G06Q 20/38; G06Q 20/32

(52) U.S. Cl. CPC G06Q 20/3821; G06Q 20/322

(57) ABSTRACT

A method of credential-based electronic payment processing involves a credential processing server receiving from a mobile communications device a payment initiation request for initiating payment with a payment terminal, and providing the mobile communications device with a mode authorization for an authorized communications mode for the mobile communications device to provide the payment terminal with a payment pre-authorization credential. The payment pre-authorization credential is uniquely associated with a financial account and pre-authorizes electronic payment from the financial account. The credential processing server receives from the payment terminal a payment clearing request that identifies a payment amount and includes the payment pre-authorization credential. The credential processing server determines particulars of the financial account from the payment pre-authorization credential, and effects settlement of the electronic payment by forwarding over a payment network a settlement request message identifying the payment amount and the financial account particulars.

### RELATED APPLICATIONS

This patent application claims the benefit of the filing date of U.S. Patent Application Ser. No. 62/022,831 filed Jul. 10, 2014, which is hereby incorporated by reference herein in its entirety.

### FIELD OF THE INVENTION

This patent application relates to a method and network for processing electronic payments at a payment terminal.

### BACKGROUND

A common problem with conventional payment card-based transactions is that the payment card may be used by an authorized party without the knowledge or approval of the cardholder. Although the cardholder can report the loss of theft of a payment card, the card issuer might authorize several financial transactions initiated with the payment card until the loss or theft is reported and acted upon by the card issuer.

In an attempt to address this deficiency, payment processing schemes have been developed in which the payor provides the merchant's payment terminal with a single-use electronic payment credential that acts as a replacement for a payment card. However, this approach is of limited value since not all payment terminals are configured to accept payment credentials.

### SUMMARY

This patent application discloses a credential processing server, a mobile communications device and associated methods that effect payment for a financial transaction using an electronic payment credential that can be accepted at multiple payment terminals.

In accordance with a first aspect of the disclosure, there is provided a method of credential-based electronic payment processing involves a credential processing server receiving from a mobile communications device a payment initiation request for initiating payment with a payment terminal, and providing the mobile communications device with a mode authorization for an authorized communications mode for the mobile communications device to provide the payment terminal with a payment pre-authorization credential. The payment pre-authorization credential is uniquely associated with a financial account and pre-authorizes electronic payment from the financial account.

The credential processing server receives from the payment terminal a payment clearing request that identifies a payment amount and includes the payment pre-authorization credential. The credential processing server determines particulars of the financial account from the payment pre-authorization credential, and effects settlement of the electronic payment by forwarding over a payment network a settlement request message identifying the payment amount and the financial account particulars.

In accordance with this first aspect of the disclosure, there is also provided a credential processing server that comprises a computer processing system that is configured to receive from a mobile communications device a payment initiation request for initiating payment with a payment terminal, and to provide the mobile communications device with a mode authorization for an authorized communications mode for the mobile communications device to provide the payment terminal with a payment pre-authorization credential. The payment pre-authorization credential is uniquely associated with a financial account and pre-authorizes electronic payment from the financial account.

The computer processing system is also configured to receive from the payment terminal a payment clearing request that identifies a payment amount and includes the payment pre-authorization credential. The computer processing system is further configured to determine particulars of the financial account from the payment pre-authorization credential, and effect settlement of the electronic payment by forwarding over a payment network a settlement request message identifying the payment amount and the financial account particulars.

In accordance with a second aspect of the disclosure, there is provided a method of credential-based electronic payment processing that involves a mobile communications device providing a credential processing server with a payment initiation request for initiating payment with a payment terminal, receiving from the credential processing server a mode authorization for an authorized communications mode, and providing the payment terminal with a payment pre-authorization credential via the authorized communications mode.

The payment pre-authorization credential is uniquely associated with a financial account and pre-authorizes electronic payment from the financial account. The payment terminal is configured to provide the credential processing server with a payment clearing request that identifies a payment amount and includes the payment pre-authorization credential.

In accordance with this second aspect of the disclosure, there is also provided a mobile communications device that comprises a data processing system that is configured to provide a credential processing server with a payment initiation request for initiating payment with a payment terminal, receive from the credential processing server a mode authorization for an authorized communications mode, and provide the payment terminal with a payment pre-authorization credential via the authorized communications mode.

The payment pre-authorization credential is uniquely associated with a financial account and pre-authorizes electronic payment from the financial account. The payment terminal is configured to provide the credential processing server with a payment clearing request that identifies a payment amount and includes the payment pre-authorization credential.

The mode authorization received from the credential processing server may include the payment pre-authorization credential and an authorization code. Alternately, the mobile communications device may be configured with the payment pre-authorization credential prior to the credential processing server receiving the payment initiation request, and the mode authorization may include the authorization code. In either case, the authorization code authorizes the authorized communications mode on the mobile communications device.

In accordance with a third aspect of the disclosure, there is provided a method of credential-based electronic payment processing that involves a credential processing server receiving from a mobile communications device a payment initiation request for initiating payment with a payment terminal, and providing the mobile communications device with a payment pre-authorization credential over a first communications network. The payment pre-authorization credential is uniquely associated with a financial account and pre-authorizes electronic payment from the financial account.

The credential processing server receives from the payment terminal over a second communications network a payment clearing request that identifies a payment amount and includes the payment pre-authorization credential. The second communications network is distinct from the first communications network. The credential processing server determines particulars of the financial account from the payment pre-authorization credential, and effects settlement of the electronic payment by forwarding over a payment network a settlement request message identifying the payment amount and the financial account particulars.

In accordance with this third aspect of the disclosure, there is also provided a credential processing server that comprises a computer processing system that is configured to receive from a mobile communications device a payment initiation request for initiating payment with a payment terminal and to provide the mobile communications device with a payment pre-authorization credential over a first communications network. The payment pre-authorization credential is uniquely associated with a financial account and pre-authorizes electronic payment from the financial account.

The computer processing system is configured to receive from the payment terminal over a second communications network a payment clearing request that identifies a payment amount and includes the payment pre-authorization credential. The second communications network is distinct from the first communications network. The computer processing system is also configured to determine particulars of the financial account from the payment pre-authorization credential, and effect settlement of the electronic payment by forwarding over a payment network a settlement request message identifying the payment amount and the financial account particulars.

In accordance with a fourth aspect of the disclosure, there is provided a method of credential-based electronic payment processing that involves a pin-pad terminal receiving from a mobile communications device, via a first communications network, a payment pre-authorization credential for effecting payment for a financial transaction. The payment pre-authorization credential is uniquely associated with a financial account and pre-authorizes electronic payment from the financial account.

The pin-pad terminal provides a credential processing server with a payment clearing request that initiates clearing of the electronic payment in a payment amount from the financial account. The payment clearing request identifies the payment amount and includes the payment pre-authorization credential.

The pin-pad terminal receives from the credential processing server an authorization confirmation message indicating a validity of the payment pre-authorization credential. The pin-pad terminal receives the authorization confirmation message via a second communications network that is distinct from the first communications network. The pin-pad terminal displays a notification of confirmation for the electronic payment in accordance with the authorization confirmation message.

In accordance with this fourth aspect of the disclosure, there is also provided a credential processing server that comprises a computer processing system that is configured to receive from a mobile communications device, via a first communications network, a payment pre-authorization credential for effecting payment for a financial transaction. The payment pre-authorization credential is uniquely associated with a financial account and pre-authorizes electronic payment from the financial account.

The computer processing system is configured to provide a credential processing server with a payment clearing request initiating clearing of the electronic payment in a payment amount from the financial account. The payment clearing request identifies the payment amount and includes the payment pre-authorization credential.

The computer processing system is also configured to receive from the credential processing server, via a second communications network that is distinct from the first communications network, an authorization confirmation message indicating a validity of the payment pre-authorization credential, and to display a notification of confirmation for the electronic payment in accordance with the authorization confirmation message.

In one implementation, the credential processing server receives from the mobile communications device location information identifying the current location of the mobile communications device, determines at least one available communications mode for the payment terminal from the location information, and generates the authorized communications mode from the at least one available communications mode and at least one communications capability of the mobile communications device. The location information may comprise one of a vendor identifier and geographical data.

Since the format of the payment pre-authorization credential is transformed by mobile device based on the available communications mode(s) of the payment terminal and the communications capabilities of the mobile communications device, the solution is not limited by the hardware limitations of the payment terminal or the mobile device. Moreover, since the credential can provide the payment terminal with confirmation that the financial transaction has been pre-authorized, instead of merely serving as a substitute for a payment card number that must be authorized online, the financial transaction can be completed more quickly than conventional electronic payment schemes.

### BRIEF DESCRIPTION OF THE DRAWINGS

An exemplary credential-based payment processing network, mobile communications device, credential processing server, and method of credential-based payment processing will now be described, with reference to the accompanying drawings, in which:

FIG. 1 is a schematic view of the credential-based payment processing network, depicting a mobile communications device, a payment terminal, and a credential processing server;

FIG. 2 is a schematic view of one of the mobile communications devices;

FIG. 3 is a schematic view of the credential processing server; and

FIGS. 4a and 4b together comprise a message flow diagram depicting the method of credential-based payment processing.

### DETAILED DESCRIPTION

### Payment Processing Network

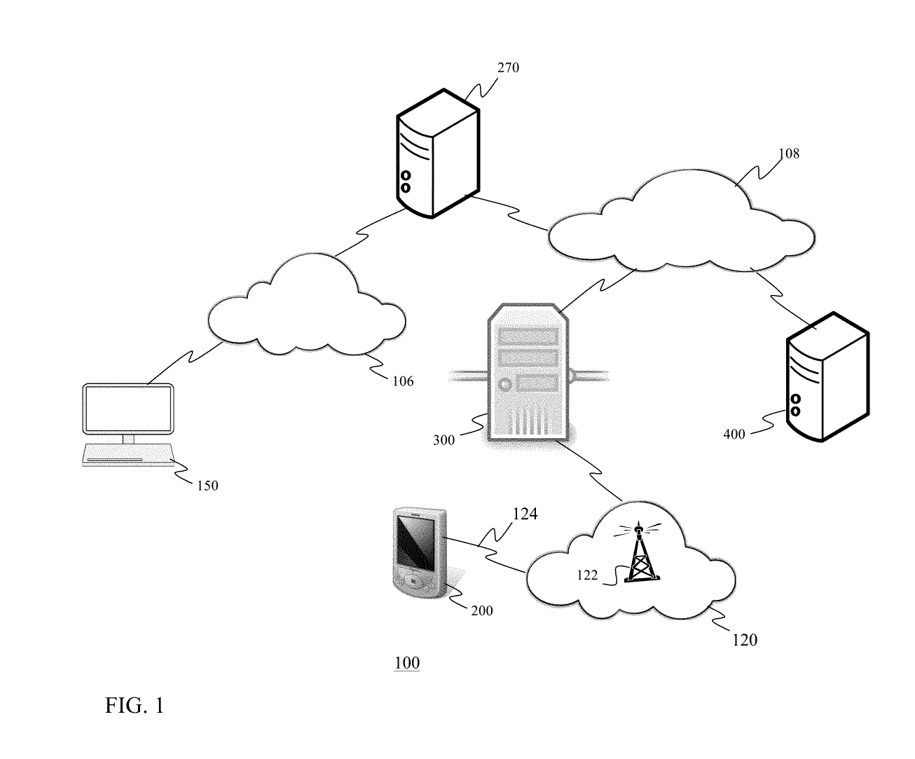

FIG. 1 is a schematic view of payment processing network, denoted generally as 100. As shown, the payment processing network 100 comprises a payment terminal 150, a mobile device 200, an acquirer server 270, a credential processing server 300, and a financial institution server 400. Although the payment processing network 100 is shown comprising only a single payment terminal 150, a single mobile device 200, a single acquirer server 270, and a single financial institution server 400, the payment processing network 100 typically includes a plurality of the payment terminals 150, a plurality of the mobile devices 200, a plurality of the acquirer servers 270, and a plurality of the financial institution servers 400.

The payment terminals 150 are typically deployed at a merchant's business premises, and are configured to communicate with one of the acquirer servers 270 via a secure acquirer network 106.

The mobile devices 200 are typically implemented as wireless communications devices that are configured to operate within a wireless network. Accordingly, preferably the payment processing network 100 includes a mobile communications network 120. The mobile communications network 120 may be configured as a WiFi network, a cellular network, or a combination thereof. As shown, the mobile communications network 120 comprises a plurality of wireless base station subsystems 122. The mobile devices 200 communicate with the base station subsystems 122 via wireless links 124, and the base station subsystems 122 communicate with the credential processing server(s) 300 via a wired, wireless or optical link. Accordingly, the base station subsystems 122 act as a bridge between the mobile devices 200 and the credential processing server(s) 300.

Each acquirer server 270 is associated with a financial institution of one or more merchants, and is configured to communicate with the payment terminals 150 via the acquirer network 106. The acquirer servers 270 are also configured to communicate with the credential processing server 300 via a via a payment network 108, such as VisaNet®, the Mastercard® Network or the Interac® Network, that is distinct from the acquirer network 106 and the mobile communications network 120.

Each financial institution server 400 is associated with and administered by a respective financial institution. Each financial institution server 400 maintains financial accounts for each of a plurality of its customers, and is configured to communicate with the credential processing server 300 via the payment network 108.

The credential processing server 300 is configured to communicate with the mobile devices 200 via the mobile communications network 120, and is also configured to communicate with the acquirer servers 270 and the financial institution servers 400 via the payment network 108. The credential processing server 300 issues payment pre-authorization credentials to financial institution customers, and maintains a mapping between the payment pre-authorization credentials and the financial accounts maintained by the financial institution servers 400.

Although the credential processing server 300 and financial institution server 400 are shown in FIG. 1 as being separate entities, the functionality of the credential processing server 300 may be incorporated into one or more of the financial institution servers 400.

### Payment Terminal

The payment terminal 150 includes an input device, a display device, and a computer processing subsystem that is coupled to the input device and the display device. The input device may be implemented as a keyboard, touchpad, touchscreen or other input device suitable that allows a merchant to input data and/or commands that may be required to complete financial transaction, such as a debit transaction. The display device may be implemented as a liquid crystal display (LCD) panel, cathode ray tube (CRT) display, plasma display panel, or other display device suitable for displaying transaction information to the user.

The payment terminal 150 may also include a payment credential reader that is coupled to the computer processing system and is configured to communicate with mobile devices 200 that are in close physical proximity to the payment terminals 150. The payment credential reader may comprise a bar code (1-D and/or 2-D (e.g. Quick Response code)) reader, and/or a wireless transmitter/receiver that uses short-range communications protocols, such as WiFi, Bluetooth and/or Near Field Communications (NFC), to communicate with the mobile devices 200.

As non-limiting examples, one or more of the payment terminals 150 may be implemented as an integrated point-of-sale (POS) terminal, a pin-pad terminal that communicates with respective electronic cash register (ECR), or a mobile wireless communications device that is configured to process electronic payment requests. As will be explained, the payment terminal 150 receives a payment pre-authorization credential from one of the mobile devices 200 (either manually input via the input device or received via the payment credential reader), and is configured to provide the credential processing server 300 with a payment clearing request that identifies a payment amount and includes the payment pre-authorization credential.

The terminal manufacturer may configure the payment terminal 150 with a public cryptographic key (disposed within a X.509 digital certificate) of the credential processing server 300 to thereby allow the payment terminal 150 to validate a payment pre-authorization credential received from a mobile device 200.

### Mobile Device

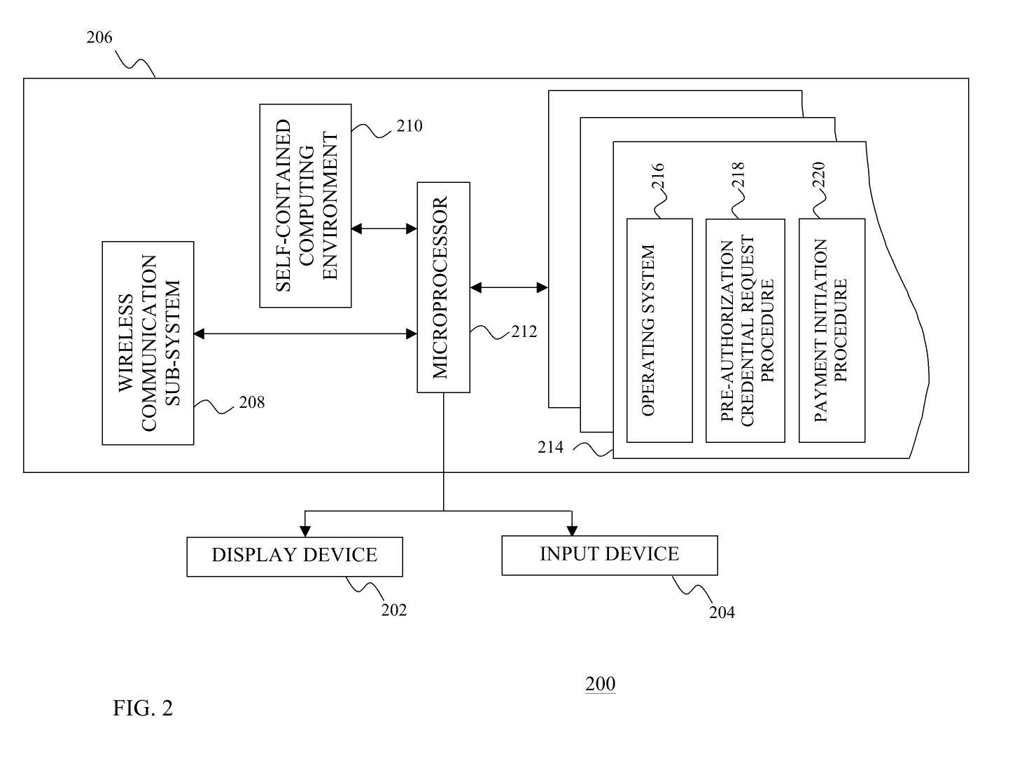

A sample mobile device 200, implemented as a wireless communications device, is depicted in FIG. 2. As shown, the mobile device 200 includes a display device 202, user input device 204, and a computer processing system 206. The user input device 204 may be provided as a keyboard, biometric input device (e.g. microphone) and/or a touch-sensitive layer provided on the display device 202. The computer processing system 206 comprises a wireless communication sub-system 208, a self-contained computing environment 210, a microprocessor 212, and a memory 214.

The wireless communication sub-system 208 allows the mobile device 200 to communicate over the mobile communications network 120. As discussed, the mobile communications network 120 may be configured as a WiFi network, a cellular network, or a combination thereof. Accordingly, the communication sub-system 208 allows the mobile device 200 to transmit and receive wireless communications signals over WiFi networks and/or cellular networks. Preferably the communication sub-system 208 is also configured to allow the mobile device 200 to wirelessly communicate with nodes (e.g. payment terminals 150) that are in close proximity to the mobile device 200, using short-range communications protocols, such as Bluetooth and/or NFC as examples.

The self-contained computing environment 210 provides a secure computing environment for running cryptographic (e.g. data encryption standard (DES), triple-DES, advanced encryption standard (AES)) algorithms, and comprises protected memory and a micro-controller. The protected memory may store a payment pre-authorization credential, and may also identify a pre-authorized payment amount that may be withdrawn from a financial account (maintained by one of the financial institution servers 400) using the payment pre-authorization credential. The payment pre-authorization credential may consist of a series of numbers, letters and/or symbols, and is uniquely associated with the respective financial account by the credential processing server 300.

The memory 214 of the mobile device 200 typically comprises non-removable non-volatile memory, and stores non-transient computer processing instructions thereon which, when accessed from the memory 214 and executed by the microprocessor 212, implement an operating system 216, a pre-authorization credential request procedure 218 and payment initiation procedure 220. The operating system 216 is configured to display output on the display device 202, to receive manual input from the input device 204, to send and receive communication signals over the wireless link 124 of the mobile communications network 120, and to send and receive short-range communication signals to/from proximate nodes (e.g. payment terminals 150) of the payment processing network 100.

The operation of the pre-authorization credential request procedure 218 and the payment initiation procedure 220 will be discussed in greater detail below. However, it is sufficient at this point to note that the pre-authorization credential request procedure 218 is configured to request a payment pre-authorization credential from the credential processing server 300, and to save the pre-authorization credential in the protected memory of the self-contained computing environment 210.

The payment initiation procedure 220 is configured to (i) provide the credential processing server 300 with a payment initiation request to initiate an electronic payment with a payment terminal 150, (ii) receive from the credential processing server 300 a mode authorization for an authorized communications mode, and (iii) provide the payment terminal 150 with a payment pre-authorization credential via the authorized communications mode. As discussed above, the payment pre-authorization credential is uniquely associated with a financial account and pre-authorizes electronic payment from the financial account, and the payment terminal 150 is configured to provide the credential processing server 300 with a payment clearing request that identifies a payment amount and includes the payment pre-authorization credential.

Although the pre-authorization credential request procedure 218 and the payment initiation procedure 220 are typically implemented as computer processing instructions, all or a portion of the functionality of the pre-authorization credential request procedure 218 and the payment initiation procedure 220 may be implemented instead in electronics hardware.

### Credential Processing Server

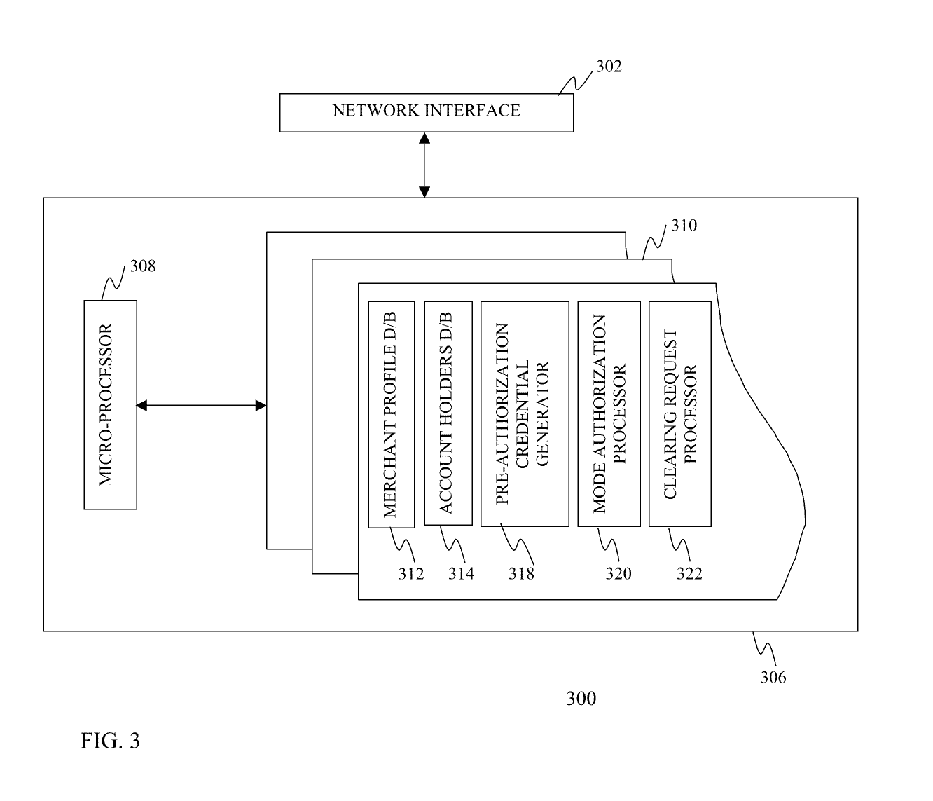

The credential processing server 300 comprises a computer server, and is configured to process financial transactions that are initiated at the payment terminal(s) 150. As shown in FIG. 3, the credential processing server 300 includes a network interface 302, and a computer processing system 306 that is coupled to the network interface 302.

The network interface 302 interfaces the credential processing server 300 with the base station subsystems 122 of the mobile communications network 120 to thereby allow the credential processing server 300 to communicate with the mobile devices 200. The network interface 302 also interfaces the credential processing server 300 with the payment network 108 to thereby allow the credential processing server 300 to communicate with the acquirer servers 270 and the financial institution servers 400.

The network interface 302 may also allow the credential processing server 300 to communicate with communications devices (e.g. a personal computer, a mobile device 200), via, for example the mobile communications network 120 or another communications network, to thereby allow financial institution customers to specify the communications capabilities of their respective mobile devices 200, the particulars (e.g. account number) of their respective financial accounts, and optionally also a maximum pre-authorized payment amount that may be withdrawn from their financial account using the payment processing network 100.

The computer processing system 306 may include one or more microprocessors 308 and a computer-readable medium 310. The computer-readable medium 310 may be provided as electronic computer memory (e.g. flash memory) or optical or magnetic memory (e.g. compact disc, hard disk). The computer-readable medium 310 maintains an asymmetric cryptographic key pair (comprising a private cryptographic key, and a corresponding public cryptographic key that is disposed within a X.509 digital certificate), a merchant profile database 312, and an account holders database 314.

The merchant profile database 312 includes a plurality of clusters each uniquely associated with a respective merchant that is enrolled in the payment processing network 100. Preferably, each cluster of the merchant profile database 312 identifies a respective merchant and the communications capabilities of the merchant's payment terminals 150. For example, the merchant profile database 312 may save a merchant ID (e.g. the name of the merchant's store) that is uniquely associated with the merchant, and may identify the communications mode(s) (e.g. manual input, 1-D bar code reader, 2-D bar code reader, WiFi transmitter/receiver, Bluetooth transmitter/receiver, NFC transmitter/receiver) over which the merchant's payment terminals 150 can receive a payment pre-authorization credential. The merchant profile database 312 may also identify the location(s) of the merchant's store(s).

The account holders database 314 includes a plurality of clusters each uniquely associated with a respective financial institution customer. Preferably, each cluster of the account holders database 314 stores authentication credentials (e.g. username/userID, password) that the customer uses to authenticate to the credential processing server 300, particulars (e.g. account number) of the customer's financial account, a cryptographic key, a transaction counter, and a single-use payment pre-authorization credential that is uniquely associated with the financial account. Each cluster of the account holders database 314 may also identify the maximum pre-authorized payment amount that may be withdrawn from the customer's financial account using their payment pre-authorization credential.

The transaction counter is incremented each time a new payment pre-authorization credential for the financial account is generated. The cryptographic key is uniquely associated with the financial institution customer, and is used to generate the payment pre-authorization credential. The financial institution may generate the cryptographic key from the account number and a cryptographic master key of the financial institution, and may provide the credential processing server 300 with the authentication credentials, account number and cryptographic key for each financial institution customer as a batch download to the credential processing server 300.

Each cluster of the account holders database 314 may also identify the communications capabilities of the mobile device 200 used by the financial institution customer. For example, the account holders database 314 may identify the communications mode(s) (e.g. display a code, a 1-D bar code or a 2-D bar code, or wirelessly transmit by WiFi, Bluetooth or NFC) over which the subscriber's mobile device 200 can transmit a payment pre-authorization credential to a payment terminal 150.

The computer-readable medium 310 also stores non-transient computer processing instructions thereon which, when executed by the microprocessor(s) 308, define an operating system (not shown) that controls the overall operation of the credential processing server 300. The computer processing instructions also implement a pre-authorization credential generator 318, a mode authorization processor 320, and a clearing request processor 322.

The operation of the pre-authorization credential generator 318, the mode authorization processor 320, and the clearing request processor 322 will be discussed in greater detail below. However, it is sufficient at this point to note that the pre-authorization credential generator 318 is configured to generate a cryptogram from particulars of a financial institution customer's financial account and the pre-authorized payment amount that may be withdrawn from the customer's financial account, and to send the issuer server 400 an Authorization Request Message that includes the cryptogram and requests pre-authorization for a financial transaction in a pre-authorized payment amount using the customer's financial account. The pre-authorization credential generator 318 is also configured to generate a single-use payment pre-authorization credential from a cryptographic key and at least one datum that is associated with the customer, and to transmit the payment pre-authorization credential to the mobile device 200.

The mode authorization processor 320 is configured to (i) receive from a mobile device 200 a payment initiation request for initiating an electronic payment with a payment terminal 150, and (ii) provide the mobile device 200 with a mode authorization for an authorized communications mode for the mobile device 200 to provide the payment terminal 150 with a single-use payment pre-authorization credential. The single-use payment pre-authorization credential is uniquely associated with the customer's financial account and pre-authorizes electronic payment from the financial account, but does not identify the customer or the account number of the customer's financial account.

The clearing request processor 322 is configured to (i) receive from the payment terminal 150 a clearing request that identifies a payment amount and includes the payment pre-authorization credential, (ii) determine particulars (e.g. account number) of the associated financial account from the payment pre-authorization credential, and (iii) effect settlement of the electronic payment by forwarding over the payment network 108, to the appropriate financial institution server 400, a settlement request message that identifies the payment amount and the particulars of the financial account.

Although the pre-authorization credential generator 318, the mode authorization processor 320 and the clearing request processor 322 are typically implemented as computer processing instructions, all or a portion of the functionality of the pre-authorization credential generator 318, the mode authorization processor 320 and/or the clearing request processor 322 may be implemented instead in electronics hardware.

### Financial Institution Server

Each financial institution server 400 is implemented as a computer server, and is configured to effect financial transactions (e.g. credit transaction, debit transaction) from the financial accounts maintained by the associated financial institution. Each financial account may comprise any of a savings account, a chequing account, a credit account and a line of credit account.

The financial institution server 400 maintains a secure accounts database that includes a plurality of clusters each associated with a respective financial account. Each cluster typically identifies the account number of the associated financial account, and the credit/deposit entries to the associated financial account.

### Method of Payment Processing

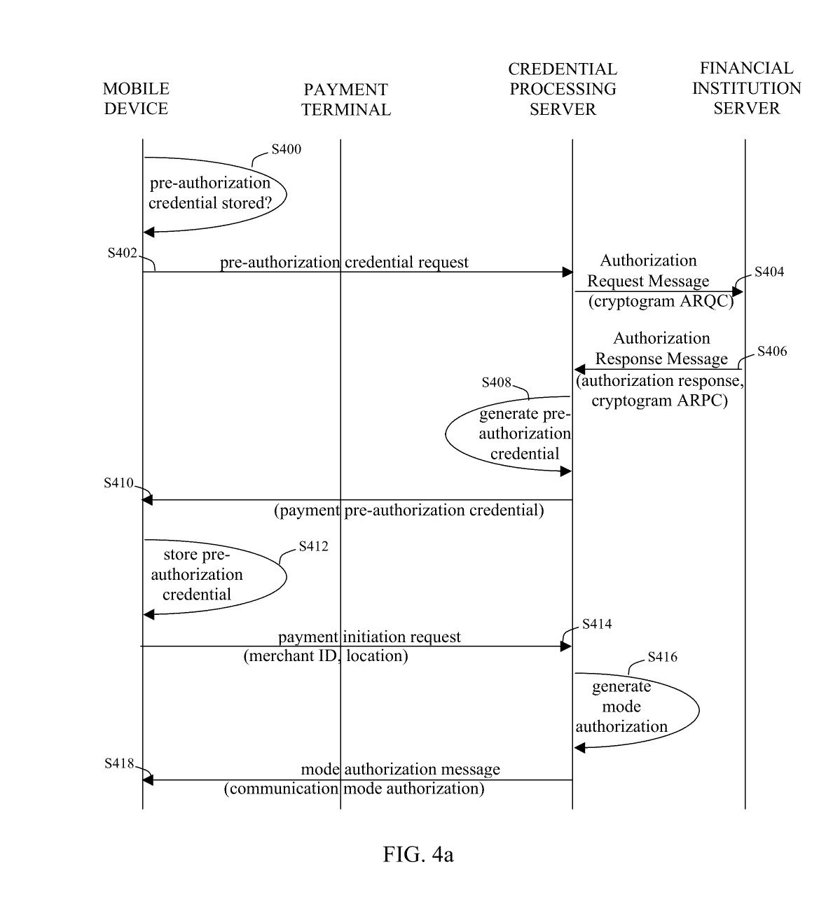

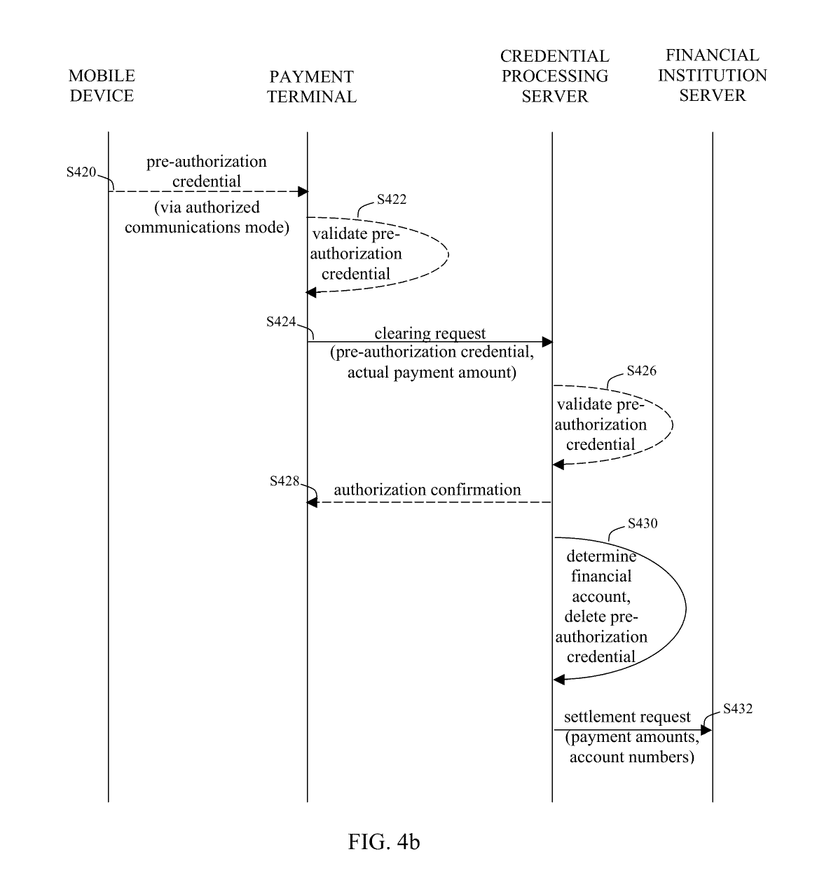

As discussed, the payment processing network 100 implements a method of cloud-based payment processing. A sample embodiment of the payment method will be discussed with reference to FIGS. 4a and 4b. As will be explained, in this embodiment the credential processing server 300 receives from one of the mobile devices 200 a payment initiation request for initiating payment with a payment terminal 150, and provides the mobile device 200 with a mode authorization for an authorized communications mode for the mobile device 200 to provide the payment terminal 150 with a payment pre-authorization credential. The payment pre-authorization credential is uniquely associated with a financial account and pre-authorizes electronic payment from the financial account.

The credential processing server 300 receives from the payment terminal 150 a payment clearing request that identifies a payment amount and includes the payment pre-authorization credential, determines particulars of the financial account from the payment pre-authorization credential, and effects settlement of the electronic payment by forwarding over the payment network 108 a settlement request message that identifies the payment amount and the financial account particulars.

In this embodiment, the mobile device 200 provides the credential processing server 300 with a payment initiation request for initiating payment with a payment terminal 150, and receives from the credential processing server 300 a mode authorization for an authorized communications mode. The mobile device 200 then provides the payment terminal 150 with a payment pre-authorization credential via the authorized communications mode. The payment pre-authorization credential is uniquely associated with a financial account and pre-authorizes electronic payment from the financial account. The payment terminal 150 is configured to provide the credential processing server 150 with a payment clearing request that identifies a payment amount and includes the payment pre-authorization credential.

An example debit transaction using the payment processing network 100 will now be discussed in detail with reference to FIGS. 4a and 4b. At the outset, the financial institution customer may use a communications device (e.g. a personal computer, a mobile device 200) to authenticate to the financial institution server 400, and to specify a maximum pre-authorized payment amount to be used with the payment processing network 100. As discussed, the financial institution server 400 may provide the credential processing server 300, via an communications encrypted channel, with the account number of each customer's financial account, and the authentication credentials (e.g. username/userID, passcode) that each customer will use to authenticate to the credential processing server 300.

The credential processing server 300 saves the received information in the account holders database 314. Thereafter, the customer (device user) may attend at a payment terminal 200 of a merchant to complete a financial transaction (e.g. pay for wares and/or services) with the merchant. The device user may use the input device 204 of the mobile device 200 to invoke the payment initiation procedure 220 and thereby initiate electronic payment for the financial transaction. In response, the payment initiation procedure 220 may invoke the pre-authorization credential request procedure 218 on the mobile device 200.

### Confirm Payment Pre-Authorization

The pre-authorization credential request procedure 218 on the mobile device 200 queries the self-contained computing environment 210 of the mobile device 200, at step S400, to determine whether the protected memory thereof has stored a payment pre-authorization credential. If the self-contained computing environment 210 reports that the protected memory is already storing a payment pre-authorization credential, the pre-authorization credential request procedure 218 notifies the payment initiation procedure 220 and processing proceeds to step S414. Otherwise, the mobile device 200 attempts to authenticate the device user to the credential processing server 300 via the mobile communications network 120.

Typically, the device user authenticates to the credential processing server 300 by establishing an encrypted communications channel with the credential processing server 300, and providing the credential processing server 300 with the device user's (financial institution customer's) authentication credentials (e.g. username/userID, passcode), via the encrypted channel. The credential processing server 300 authenticates the device user by validating the provided authentication credentials against the authentication credentials that are associated with the financial institution customer in the account holders database 314.

After the device user successfully authenticates to the credential processing server 300, at step S402 the pre-authorization credential request procedure 218 transmits to the credential processing server 300 a pre-authorization credential request requesting a payment pre-authorization credential from the credential processing server 300. In response, the pre-authorization credential generator 318 of the credential processing server 300 generates a cryptogram (ARQC) from particulars of the device user's financial account and the pre-authorized payment amount that may be withdrawn from the device user's financial account, and sends the issuer server 400 an Authorization Request Message that requests pre-authorization for a financial transaction in the pre-authorized payment amount from the device user's financial account. The Authorization Request Message includes the cryptogram and excludes the particulars of the device user and the device user's financial account.

The pre-authorization credential generator 318 may generate the cryptogram (ARQC) from the cryptographic key that is associated with the device user's financial account in the account holders database 314, and from a message authentication code that is generated from the pre-authorized payment amount, an unpredictable number, the current date, the account number of the device user's financial account, and the transaction counter that is associated with the device user's financial account in the account holders database 314 (collectively “Issuer Authorization Data”). The pre-authorization credential generator 318 may increment the transaction counter after generating the cryptogram ARQC, and may generate the unpredictable number from a pseudo-random number generator.

The pre-authorization credential generator 318 may generate the cryptogram ARQC by (i) querying the account holders database 314 with the device user's authentication credentials for the account number of the device user's financial account and for the pre-authorized payment amount, the transaction counter and the cryptographic key that are associated with the device user's financial account, (ii) generating a session key from the transaction counter and the cryptographic key, (iii) generating a message authentication code from the Issuer Authorization Data and (iv) applying the Issuer Authorization Data and the session key as inputs to a cryptographic algorithm.

At step at step S404, the pre-authorization credential generator 318 generates the Authorization Request Message that includes the Issuer Authorization Data and the cryptogram ARQC, and directs the Authorization Request Message, over the payment network 108, to the issuer server 400 that maintains the device user's financial account. The Authorization Request Message is directed to the appropriate issuer server 400 based on the IIN of the account number. The Authorization Request Message requests pre-authorization for a financial transaction in the pre-authorized payment amount using the specified financial account.

The issuer server 400 validates the cryptogram ARQC by confirming that the cryptogram was generated by the pre-authorization credential generator 318 from the account number and the pre-authorized payment amount. To do so, the issuer server 400 may (i) recover the session key by applying the account number, transaction counter and the financial institution's cryptographic master key as inputs to a suitable cryptographic algorithm, (ii) decrypt the cryptogram ARQC with the recovered session key, (iii) compute a message authentication code from the Issuer Authorization Data, and (iv) compare the computed message authentication code against the decrypted cryptogram.

The issuer server 400 also applies its prevailing risk management rules to the pre-authorized payment amount. Therefore, for example, the issuer server 400 may determine whether the financial account that is associated with the account number is still active and has sufficient credit/funds to complete the transaction (i.e. the pre-authorized payment amount is less than the balance for the account).

Based on the outcome of the risk management analysis and the cryptogram ARQC validation, the issuer server 400 may generate a merchant authorization code that indicates whether the financial institution authorized the financial transaction in the pre-authorized payment amount, and may reserve in the financial account an amount for subsequent withdrawal equal to the pre-authorized payment amount. The issuer server 400 may also generate a cryptogram (ARPC) from the cryptogram ARQC and the merchant authorization code. The issuer server 400 may generate the cryptogram ARPC by applying the merchant authorization code, cryptogram ARQC and session key as inputs to a suitable cryptographic algorithm. The issuer server 400 may also confirm that the cryptogram ARPC does not identify the device user or the account number of the device user's financial account. Alternately, the cryptographic algorithms used by the issuer server 400 may ensure this result.

At step S406, the issuer server 400 generates an Authorization Response Message that includes the Issuer Authorization Data, merchant authorization code and cryptogram ARPC, and returns the Authorization Response Message to the credential processing server 300 via the payment network 108. In response to the Authorization Response Message, the pre-authorization credential generator 318 examines the merchant authorization code of the Authorization Response Message.

If the merchant authorization code indicates that the financial institution authorized the financial transaction in the pre-authorized payment amount, the pre-authorization credential generator 318 validates the cryptogram ARPC by confirming that the cryptogram was generated by the issuer server 400 from the merchant authorization code, the account number and the pre-authorized payment amount. To do so, the pre-authorization credential generator 318 may (i) decrypt the cryptogram ARPC with the session key, (ii) compute a message authentication code from the merchant authorization code, the account number and cryptogram ARQC, and (iii) compare the computed message authentication code against the decrypted cryptogram.

### Generate Payment Pre-Authorization Credential

If the pre-authorization credential generator 318 confirms that the issuer server 300 generated the cryptogram ARPC and that the financial institution pre-authorized the financial transaction in the pre-authorized payment amount, at step S408 the pre-authorization credential generator 318 generates a single-use payment pre-authorization credential from a cryptographic key and at least one datum (e.g. the transaction counter, the account number of the device user's financial account) that is associated with the device user. The single-use payment pre-authorization credential is uniquely associated with the device user's financial account and pre-authorizes electronic payment from the financial account., but does not identify the device user or any particulars (e.g. the account number) of the device user's financial account.

The pre-authorization credential generator 318 may generate the single-use payment pre-authorization credential from a message authentication code that is generated from another unpredictable number and the current date, and from the pre-authorized payment amount, account number and transaction counter that are associated with the device user's financial account in the account holders database 314 (collectively “Credential Authorization Data”). The pre-authorization credential generator 318 may increment the transaction counter after generating the payment pre-authorization credential, and may generate the unpredictable number from a pseudo-random number generator.

The pre-authorization credential generator 318 may generate the payment pre-authorization credential by (i) generating a session key from the transaction counter and the cryptographic key that are associated with the device user's financial account in the account holders database 314, (ii) generating a message authentication code from the Credential Authorization Data, and (iii) applying the Credential Authorization Data and the session key as inputs to a cryptographic algorithm. To allow the payment terminal 150 to be able to validate the payment pre-authorization credential, optionally the pre-authorization credential generator 318 may sign the payment pre-authorization credential (cryptogram) with the private cryptographic key of the credential processing server 300. The pre-authorization credential generator 318 may also sign the pre-authorized payment amount with the private cryptographic key of the credential processing server 300.

Since the payment pre-authorization credential is generated from the account number of the device user's financial account, the payment pre-authorization credential is uniquely associated with that financial account. Further since the payment pre-authorization credential is generated from the transaction counter and the cryptographic key that are associated with the device user's financial account, the particulars of the device user and the financial account are unrecoverable from only the payment pre-authorization credential, and the pre-authorization credential generator 318 generates a new unique payment pre-authorization credential in response to each pre-authorization credential request.

The pre-authorization credential generator 318 may prefix the payment pre-authorization credential with the Issuer Identification Number (IIN) that is assigned to the credential processing server 300 to ensure that the credential is associated with the credential processing server 300. The pre-authorization credential generator 318 then saves the merchant authorization code, payment pre-authorization credential and the Credential Authorization Data in the account holders database 314, in association with the account number of the device user's financial account.

The credential processing server 300 may transmit the payment pre-authorization credential and the signed pre-authorized payment amount to the mobile device 200 over the encrypted communications channel via the mobile communications network 120, at step S410. The credential request procedure 218 of the mobile device 200 instructs the self-contained computing environment 210 to save the payment pre-authorization credential and the signed pre-authorized payment amount in the protected memory thereof, at step S412, and may confirm to the payment initiation procedure 220 that the credential has been saved in the protected memory.

### Deliver Payment Pre Authorization Credential to Payment Terminal

After the payment initiation procedure 220 receives confirmation that the self-contained computing environment 210 has stored a payment pre-authorization credential, at step S414 the payment initiation procedure 220 of the mobile device 200 may transmit to the credential processing server 300 a payment initiation request, requesting authorization to transmit the payment pre-authorization credential to the payment terminal 150.

Alternately, to reduce the amount of time required to complete the financial transaction, the pre-authorization credential request procedure 218 may periodically query the self-contained computing environment 210 to determine whether the protected memory thereof has stored a payment pre-authorization credential, and may request a payment pre-authorization credential from the credential processing server 300 if the self-contained computing environment 210 reports that the protected memory is not currently storing a payment pre-authorization credential. Accordingly, steps S400 to S412 may be completed before the device user attends at the premises of the merchant, so that the mobile device 200 is configured with a payment pre-authorization credential before the credential processing server 300 receives the payment initiation request, and step S414 may be initiated without receiving prior confirmation that the mobile device 200 saves a payment pre-authorization credential in the self-contained computing environment 210.

The payment initiation request, transmitted to the credential processing server 300 at step S414, may include location information identifying the current location of the mobile device 200. The location information may include geographic data and/or the name (merchant ID) of the merchant store at which the device user is attending. The payment initiation procedure 220 may provide the credential processing server 300 with the name of the merchant by prompting the device user to input the merchant's name via the input device 204 of the mobile device 200. The payment initiation procedure 220 may provide the credential processing server 300 with the geographic data by determining the current location of the mobile device 200, for example, from the WiFi network and/or cellular network of the mobile communications network 120 and/or from a GPS receiver installed in the mobile device 200.

In response to the payment initiation request, the mode authorization processor 320 of the credential processing server 300 queries the merchant profile database 312 with the merchant's name and/or the location information to determine the available communications mode(s) (e.g. manual input, 1-D bar code reader, 2-D bar code reader, WiFi transmitter/receiver, Bluetooth transmitter/receiver, NFC transmitter/receiver) over which the merchant's payment terminals 150 can receive the payment pre-authorization credential. If the mode authorization processor 320 does not locate any entry in the merchant profile database 312 for the merchant or the merchant's location, the credential request processor 320 may request that the payment initiation procedure 220 prompt the device user to identify the available communications mode(s) of the merchant's payment terminals 150, for example, by displaying on the display device 202 of the mobile device 200 a list of all known communications modes and requesting that the device user identify the communications modes that are available at the merchant's payment terminals 150.

The mode authorization processor 320 also queries the account holders database 314 to determine the communications capabilities of the financial institution subscriber's mobile device 200 for transmitting a payment pre-authorization credential (e.g. display a code, a 1-D bar code or a 2-D bar code, or wirelessly transmit by WiFi, Bluetooth or NFC). If the mode authorization processor 320 does not locate any entry in the account holders database 314 for the device user's mobile device 200, the mode authorization processor 320 may request that the payment initiation procedure 220 prompt the device user to identify the available communications capabilities of the subscriber's mobile device 200, for example, by displaying on the display device 202 of the mobile device 200 a list of all known communications capabilities and requesting that the device user identify the communications capabilities that are available on the device user's mobile device 200.

At step S416, the mode authorization processor 320 generates a mode authorization code that establishes the authorized communications mode over which the mobile device 200 is authorized to provide the payment terminal 150 with the payment pre-authorization credential. The mode authorization processor 320 may generate the mode authorization code by correlating the available communications mode(s) of the merchant's payment terminals 150 with the communications capabilities of the subscriber's mobile device 150. Therefore, for example, if the merchant's payment terminals 150 can only receive a payment pre-authorization credential via Bluetooth and NFC, and the subscriber's mobile device 200 can transmit a payment pre-authorization credential only by displaying a 1-D bar code or a 2-D bar code on the display device 202 or by wirelessly transmitting via NFC, the mode authorization code would establish NFC as the authorized communications mode.

In one variation, the merchant profile database 312 (or the account holders database 314) includes a rank value assigned to each of the communications mode(s) of the merchant's payment terminals 150 (or to each of the available communications capabilities of the subscriber's mobile device 200). In the event that the available communications capabilities of the subscriber's mobile device 200 correlate with two or more of the communications mode(s) of the merchant's payment terminals 150, the communications mode authorized by the mode authorization code may be determined based on the rank value of the communications mode(s) (or available communications capabilities).

The credential processing server 300 may incorporate the mode authorization code into a mode authorization message, and transmit the mode authorization message to the mobile device 200 over the encrypted communications channel via the mobile communications network 120, at step S418. In one variation, the credential processing server 300 does not transmit the payment pre-authorization credential (and signed pre-authorized payment amount) to the mobile device 200 at step S410, but instead incorporates the payment pre-authorization credential (and signed pre-authorized payment amount) and the mode authorization code into an augmented mode authorization message transmits the augmented mode authorization message to the mobile device 200 at step S418. This variation is advantageous in that the mobile device 200 need not have a self-contained computing environment 210, and need not be configured to securely store the payment pre-authorization credential and the signed pre-authorized payment amount.

The payment initiation procedure 220 of the mobile device 200 determines the authorized communication mode from the received mode authorization code, requests the payment pre-authorization credential and the signed pre-authorized payment amount from the self-contained computing environment 210 (if not transmitted to the mobile device 200 at step S418), and provides the payment terminal 150 with the payment pre-authorization credential and the signed pre-authorized payment amount via the authorized communications mode, at step S420. Therefore, for example, if the mode authorization code authorized delivery of the payment pre-authorization credential to the payment terminal 150 as a 2-D bar code, the payment initiation procedure 220 would generate a 2-D bar code from the payment pre-authorization credential and the signed pre-authorized payment amount, and would display the 2-D bar code on the display device 202 of the mobile device 200, thereby allowing the bar code to be scanned via the payment credential reader. If the mode authorization code authorized delivery of the payment pre-authorization credential via manual input to the payment terminal 150, the payment initiation procedure 220 would generate a code sequence from the payment pre-authorization credential and the signed pre-authorized payment amount, and would display the code sequence on the display device 202 of the mobile device 200, thereby allowing the code sequence to be manually input into the payment terminal 150 via the input device thereof.

### Clear Electronic Payment

After the payment terminal 150 receives the payment pre-authorization credential and the signed pre-authorized payment amount, the payment terminal 150 may confirm receipt of same to the mobile device 200. In response, the mobile device 200 may instruct the self-contained computing environment 210 of the mobile device 200 to delete the payment pre-authorization credential and the signed pre-authorized payment amount from the protected memory thereof (if stored therein at step S410). Alternately, the self-contained computing environment 210 may delete the payment pre-authorization credential and the signed pre-authorized payment amount from the protected memory upon delivery of same to the payment initiation procedure 220.

At step S422, the payment terminal 150 may validate the payment pre-authorization credential by confirming that the credential (and optionally also the pre-authorized payment amount) was generated by the pre-authorization credential generator 318. To do so, the payment terminal 150 uses the public cryptographic key that is associated with the private cryptographic key of the credential processing server 300 to confirm that the pre-authorization credential generator 318 signed the payment pre-authorization credential (and optionally also the pre-authorized payment amount) with the private cryptographic key of the credential processing server 300.

After validating the payment pre-authorization credential, the payment terminal 150 may prompt the merchant to input the actual payment amount for the financial transaction via the input device. Alternately, the payment terminal 150 may prompt the merchant for the actual payment amount prior to receiving the payment pre-authorization credential and the signed pre-authorized payment amount at step S420.

After the payment terminal 150 receives the actual payment amount and the payment pre-authorization credential and optionally also the signed pre-authorized payment amount, the payment terminal 150 may verify that the actual payment amount does not exceed the pre-authorized payment amount that was transmitted to the payment terminal 150 along with the payment pre-authorization credential. In one variation, the payment terminal 150 is not provided with the signed pre-authorized payment amount via the authorized communications mode at step S420 (and the credential processing server 300 does not transmit the signed pre-authorized payment amount to the mobile device 200 at step S410). Instead, the payment terminal 150 may be pre-configured with a global pre-authorized payment amount that is applicable to all financial transactions that are to be completed using a payment pre-authorization credential, and the payment terminal 150 may verify that the actual payment amount does not exceed the global pre-authorized payment amount.

If the payment terminal 150 determines that the actual payment amount does not exceed the (global) pre-authorized payment amount, the payment terminal 150 may display a message on the display device thereof confirming that the financial transaction has been pre-authorized by the device user's financial institution. Otherwise, if the payment terminal 150 was unable to validate the payment pre-authorization credential, or if the actual payment amount exceeded the (global) pre-authorized payment amount, the payment terminal 150 may display a message on the display device thereof advising that the financial transaction has been declined.

The payment terminal 150 then generates a clearing request message that includes the payment pre-authorization credential and the associated actual payment amount, and transmits the clearing request message to its acquirer server 270, via the acquirer network 106, at step S424, thereby initiating clearing and settlement of the saved financial transactions. The acquirer server 270 uses the IIN (if included in the payment pre-authorization credential) to direct the clearing request message to the credential processing server 300, via the payment network 108.

As will be apparent, since the credential processing server 300 provides the mobile device 200 with the payment pre-authorization credential via the mobile communications network 120, the credential processing server 300 receives the payment clearing request from the payment terminal 150 over a communications network that is distinct from the communications network over which it provided the payment pre-authorization credential.

The payment terminal 150 may transmit the clearing request message to the credential processing server 300 immediately or shortly after receiving the particulars (payment pre-authorization credential, pre-authorized payment amount) of each financial transaction. Alternately, the payment terminal 150 may save the particulars (payment pre-authorization credential, pre-authorized payment amount) of all financial transactions in memory of the payment terminal 150, and may transmit to the credential processing server 300, at the end of each business day, a single clearing request message that includes the payment pre-authorization credential and the associated actual payment amount for each financial transaction that was initiated that day.

In response to the clearing request message, at step S426 the credential processing server 300 may validate each payment pre-authorization credential included in the message. The credential processing server 300 may validate the payment pre-authorization credentials if the payment terminal 150 did not the validate the payment pre-authorization credentials or, for added security, even if the payment terminal 150 already validated the credentials.

The credential processing server 300 may validate the payment pre-authorization credentials by confirming that the credential processing server 300 generated each payment pre-authorization credential from the associated pre-authorized payment amount. To do so, the clearing request processor 322 may for each financial transaction (a) use its public cryptographic key to confirm that the pre-authorization credential generator 318 signed the payment pre-authorization credential, and (b) query the account holders database 314 with the payment pre-authorization credential for the associated Credential Authorization Data and cryptographic key, and may then (i) recover the session key by applying the transaction counter and retrieved cryptographic key as inputs to a suitable cryptographic algorithm, (ii) decrypt the cryptogram of the payment pre-authorization credential with the recovered session key, (iii) compute a message authentication code from the Credential Authorization Data, and (iv) compare the computed message authentication code against the decrypted cryptogram.

In one variation, instead of the payment terminal 150 determining whether the actual payment amount does not exceed the (global) pre-authorized payment amount, in addition to validating each payment pre-authorization credential the clearing request processor 322 determines whether the actual payment amount does not exceed the associated pre-authorized payment amount. After validating a payment pre-authorization credential (which includes verifying that the account holders database 314 includes a copy of the payment pre-authorization credential), and optionally determining whether the actual payment amount does not exceed the associated pre-authorized payment amount, the credential processing server 300 may respond to the payment terminal 150, via the acquirer server 270 and the acquirer network 106, with an authorization confirmation message, at step S428, indicating whether the clearing request processor 322 validated the payment pre-authorization credential and optionally also whether the actual payment amount exceeded the associated pre-authorized payment amount.

Based on the contents of the authorization confirmation message, the payment terminal 150 may display on the display device thereof a notification indicating whether authorization for electronic payment in the actual payment amount was confirmed. This variation is advantageous since it provides further assurance to the merchant regarding the authenticity of the payment pre-authorization credential, and ensures that the customer has not intercepted and has attempted to re-use an otherwise valid single-use payment pre-authorization credential.

As will be apparent, since the payment terminal 150 receives the authorization confirmation message via the acquirer network 106, the communications network over which it receives the authorization confirmation message is distinct from the channel (e.g. payment credential reader, input device) over which it receives the payment pre-authorization credential. This approach further enhances the security of the solution since it provides assurance to the merchant regarding the authenticity of the authorization confirmation message (and, therefore, the authenticity of the payment pre-authorization credential).

If the clearing request processor 322 successfully validates the payment pre-authorization credential (including verifying that the account holders database 314 includes a copy of the payment pre-authorization credential), and successfully verifies that the actual payment amount does not exceed the associated pre-authorized payment amount, the clearing request processor 322 determines the particulars (e.g. account number) of the financial account from the retrieved Credential Authorization Data, and purges the associated payment pre-authorization credential from the account holders database 314, at step S430.

Thereafter, typically at the end of the business day, the credential processing server 300 effects clearing and settlement of the electronic payments of all the financial transactions accumulated during the business day by transmitting over the payment network 108 a settlement request message, at step S432, that identifies the actual payment amounts and the associated financial account particulars and requests settlement of all the financial transactions with the respective financial institutions.

Since each payment pre-authorization credential (cryptogram) is generated by the credential processing server 300, the mobile devices 200 need not have cryptographic capabilities to complete the financial transactions. Moreover, since the method employed by the issuer server 400 to validate the cryptograms ARQC, and to generate the cryptograms ARPC, is similar to that currently used to authorize EMV payments, significant modifications to conventional payment networks and issuer servers is not required.

1. A method of credential-based electronic payment processing, the method comprising:
a credential processing server receiving from a mobile communications device a payment initiation request for initiating an electronic payment with a payment terminal;
the credential processing server providing the mobile communications device with a mode authorization for an authorized communications mode for the mobile communications device to provide the payment terminal with a payment pre-authorization credential, the payment pre-authorization credential being uniquely associated with a financial account and pre-authorizing electronic payment from the financial account;
the credential processing server receiving from the payment terminal a payment clearing request identifying a payment amount and including the payment pre-authorization credential; and
the credential processing server determining particulars of the financial account from the payment pre-authorization credential, and effecting settlement of the electronic payment by forwarding over a payment network a settlement request message identifying the payment amount and the financial account particulars.

2. The method according to claim 1, wherein the receiving a payment initiation request comprises the credential processing server receiving from the mobile communications device location information identifying a current location of the mobile communications device, determining at least one available communications mode for the payment terminal from the location information, and generating the authorized communications mode from the at least one available communications mode and at least one communications capability of the mobile communications device.

3. The method according to claim 2, wherein the location information comprises one of a vendor identifier and geographical data.

4. The method according to claim 2, wherein the mobile communications device is configured with the payment credential prior to the credential processing server receiving the payment initiation request, and the mode authorization includes an authorization code authorizing the generated communications mode on the mobile communications device.

5. The method according to claim 2, wherein the generating the authorized communications mode comprises the credential processing server generating the payment credential from a cryptographic key and at least one datum associated with a user of the mobile communications device, and the mode authorization includes the payment credential and further includes an authorization code authorizing the generated communications mode on the mobile communications device.

6. The method according to claim 1, wherein the payment credential is uniquely associated with the financial account in a credential database, and the determining the financial account comprises the credential processing server querying the credential database with the payment credential.

7. The method according to claim 6, wherein the payment credential comprises a single-use payment credential, and the effecting the settlement for the electronic payment comprises the credential processing server purging the single-use payment credential from the credential database.

8. The method according to claim 1, wherein the payment credential excludes particulars of the financial account and excludes particulars of a legal person associated with the financial account, and the particulars of the legal person and the financial account are unrecoverable from only the payment credential.

9. The method according to claim 8, wherein the payment initiation request excludes the particulars of the legal person and the financial account.

10. The method according to claim 1, wherein the credential processing server provides the mobile communications device with the payment pre-authorization credential over a first communications network, and receives the payment clearing request from the payment terminal over a second communications network that is distinct from the first communications network.

11. A credential processing server comprising:
a computer processing system configured to:
(i) receive from a mobile communications device a payment initiation request for initiating an electronic payment with a payment terminal;
(ii) provide the mobile communications device with a mode authorization for an authorized communications mode for the mobile communications device to provide the payment terminal with a payment pre-authorization credential, the payment pre-authorization credential being uniquely associated with a financial account and pre-authorizing electronic payment from the financial account;
(iii) receive from the payment terminal a clearing request identifying a payment amount and including the payment pre-authorization credential; and
(iv) determine particulars of the financial account from the payment pre-authorization credential, and effect settlement of the electronic payment by forwarding over a payment network a settlement request message identifying the payment amount and the financial account particulars.

12. The credential processing server according to claim 11, wherein the payment initiation request comprises location information identifying a current location of the mobile communications device, and the credential processing server is configured to provide the mode authorization by receiving the location information from the mobile communications device, determining at least one available communications mode for the payment terminal from the location information, and generating the authorized communications mode from the at least one available communications mode and at least one communications capability of the mobile communications device.

13. The credential processing server according to claim 12, wherein the location information comprises one of a vendor identifier and geographical data.

14. The credential processing server according to claim 12, configured to provide the mobile communications device with the payment credential prior to receiving the payment initiation request, and the mode authorization includes an authorization code authorizing the generated communications mode on the mobile communications device.

15. The credential processing server according to claim 12, configured to generate the payment credential from a cryptographic key and at least one datum associated with a user of the mobile communications device, and the mode authorization includes the payment credential and further includes an authorization code authorizing the generated communications mode on the mobile communications device.

16. The credential processing server according to claim 11, wherein the payment credential is uniquely associated with the financial account in a credential database, and the credential processing server is configured to determine the financial account by querying the credential database with the payment credential.

17. The credential processing server according to claim 16, wherein the payment credential comprises a single-use payment credential, and the credential processing server is configured to effect the settlement for the electronic payment by purging the single-use payment credential from the credential database.

18. The credential processing server according to claim 11, wherein the payment credential excludes particulars of the financial account and excludes particulars of a legal person associated with the financial account, and the particulars of the legal person and the financial account are unrecoverable from only the payment credential.

19. The credential processing server according to claim 18, wherein the payment initiation request excludes the particulars of the legal person and the financial account.

20. The credential processing server according to claim 11, configured to provide the mobile communications device with the payment pre-authorization credential over a first communications network, and to receive the payment clearing request from the payment terminal over a second communications network that is distinct from the first communications network.

21. A computer-readable medium carrying computer processing instructions non-transiently stored thereon which, when executed by a computer, cause the computer to execute the method of claim 1.

22. A method of credential-based electronic payment processing, the method comprising:
a mobile communications device providing a credential processing server with a payment initiation request for initiating payment with a payment terminal;
the mobile communications device receiving from the credential processing server a mode authorization for an authorized communications mode; and
the mobile communications device providing the payment terminal with a payment pre-authorization credential via the authorized communications mode, the payment pre-authorization credential being uniquely associated with a financial account and pre-authorizing electronic payment from the financial account, the payment terminal being configured to provide the credential processing server with a payment clearing request identifying a payment amount and including the payment pre-authorization credential.

23. The method according to claim 22, wherein the providing a payment initiation request comprises the mobile communications device providing the credential processing server with location information identifying a current location of the mobile communications device, and receiving the authorized communications mode from the credential processing server in response to the location information, the credential processing server being configured to determine at least one available communications mode for the payment terminal from the location information and to generate the authorized communications mode from the at least one available communications mode and at least one communications capability of the mobile communications device.

24. The method according to claim 23, wherein the location information comprises one of a vendor identifier and geographical data.

25. The method according to claim 23, wherein the mobile communications device is configured with the payment credential prior to providing the credential processing server with the payment initiation request, the mode authorization includes an authorization code, and the mobile communications device provides the payment terminal with the payment credential via the communications mode authorized by the authorization code.

26. The method according to claim 23, wherein the mode authorization includes the payment credential and an authorization code, and the mobile communications device provides the payment terminal with the payment credential via the communications mode authorized by the authorization code.

27. The method according to claim 22, wherein the payment credential excludes particulars of the financial account and excludes particulars of a legal person associated with the financial account, and the particulars of the legal person and the financial account are unrecoverable from only the payment credential.

28. The method according to claim 27, wherein the payment initiation request excludes the particulars of the legal person and the financial account.

29. A mobile communications device comprising:
a data processing system configured to:
(i) provide a credential processing server with a payment initiation request for initiating payment with a payment terminal;
(ii) receive from the credential processing server a mode authorization for an authorized communications mode; and
(iii) provide the payment terminal with a payment pre-authorization credential via the authorized communications mode, the payment pre-authorization credential being uniquely associated with a financial account and pre-authorizing electronic payment from the financial account, the payment terminal being configured to provide the credential processing server with a payment clearing request requesting authorization for the electronic payment, the payment clearing request identifying a payment amount and including the payment pre-authorization credential.

30. The mobile communications device according to claim 29, wherein the data processing system is configured to provide the credential processing server with location information identifying a current location of the mobile communications device, and to receive the authorized communications mode from the credential processing server in response to the location information, the credential processing server being configured to determine at least one available communications mode for the payment terminal from the location information and to generate the authorized communications mode from the at least one available communications mode and at least one communications capability of the mobile communications device.

31. The mobile communications device according to claim 30, wherein the location information comprises one of a vendor identifier and geographical data.

32. The mobile communications device according to claim 30, wherein the mode authorization includes an authorization code, and the data processing system is configured with the payment credential prior to providing the credential processing server with the payment initiation request and to provide the payment terminal with the payment credential via the communications mode authorized by the authorization code.

33. The mobile communications device according to claim 30, wherein the mode authorization includes the payment credential and an authorization code, and the data processing system is configured to provide the payment terminal with the payment credential via the communications mode authorized by the authorization code.

34. The mobile communications device according to claim 29, wherein the payment credential excludes particulars of the financial account and excludes particulars of a legal person associated with the financial account, and the particulars of the legal person and the financial account are unrecoverable from only the payment credential.

35. The mobile communications device according to claim 34, wherein the payment initiation request excludes the particulars of the legal person and the financial account.

36. A computer-readable medium carrying computer processing instructions non-transiently stored thereon which, when executed by a computer, cause the computer to execute the method of claim 22.

37. A method of credential-based electronic payment processing, the method comprising:
a credential processing server receiving from a mobile communications device a payment initiation request for initiating payment with a payment terminal, and providing the mobile communications device with a payment pre-authorization credential over a first communications network, the payment pre-authorization credential being uniquely associated with a financial account and pre-authorizing electronic payment from the financial account;
the credential processing server receiving from the payment terminal over a second communications network a payment clearing request identifying a payment amount and including the payment pre-authorization credential, the second communications network being distinct from the first communications network; and
the credential processing server determining particulars of the financial account from the payment pre-authorization credential, and effecting settlement of the electronic payment by forwarding over a payment network a settlement request message identifying the payment amount and the financial account particulars.

38. A credential processing server comprising:
a computer processing system configured to:
(i) receive from a mobile communications device a payment initiation request for initiating payment with a payment terminal and to provide the mobile communications device with a payment pre-authorization credential over a first communications network, the payment pre-authorization credential being uniquely associated with a financial account and pre-authorizing electronic payment from the financial account;
(ii) receive from the payment terminal over a second communications network a payment clearing request identifying a payment amount and including the payment pre-authorization credential, the second communications network being distinct from the first communications network; and
(iii) determine particulars of the financial account from the payment pre-authorization credential, and effect settlement of the electronic payment by forwarding over a payment network a settlement request message identifying the payment amount and the financial account particulars.

39. A method of credential-based electronic payment processing, the method comprising:
a pin-pad terminal receiving from a mobile communications device via a first communications network a payment pre-authorization credential for effecting payment for a financial transaction, the payment pre-authorization credential being uniquely associated with a financial account and pre-authorizing electronic payment from the financial account;
the pin-pad terminal providing a credential processing server with a payment clearing request initiating clearing of the electronic payment in a payment amount from the financial account, the payment clearing request identifying the payment amount and including the payment pre-authorization credential;
the pin-pad terminal receiving from the credential processing server an authorization confirmation message indicating a validity of the payment pre-authorization credential, the pin-pad terminal receiving the authorization confirmation message via a second communications network distinct from the first communications network; and
the pin-pad terminal displaying a notification of confirmation for the electronic payment in accordance with the authorization confirmation message.

40. The method according to claim 39, wherein the authorization confirmation message further indicates whether the payment amount exceeds a pre-authorized payment amount.

41. The method according to claim 40, wherein the pre-authorized payment amount is associated with the financial account.

42. A pin-pad terminal comprising:
a computer processing system configured to:
(i) receive from a mobile communications device via a first communications network a payment pre-authorization credential for effecting payment for a financial transaction, the payment pre-authorization credential being uniquely associated with a financial account and pre-authorizing electronic payment from the financial account;
(ii) provide a credential processing server with a payment clearing request initiating clearing of the electronic payment in a payment amount from the financial account, the payment clearing request identifying the payment amount and including the payment pre-authorization credential;
(iii) receive from the credential processing server via a second communications network distinct from the first communications network an authorization confirmation message indicating a validity of the payment pre-authorization credential; and
(iv) display a notification of confirmation for the electronic payment in accordance with the authorization confirmation message.

43. The pin-pad terminal according to claim 42, wherein the authorization confirmation message further indicates whether the payment amount exceeds a pre-authorized payment amount.

44. The pin-pad terminal according to claim 43, wherein the pre-authorized payment amount is associated with the financial account.
